(19) United States
(12) Patent Application Publication
(10) Pub. No.: US 2013/0279170 A1
(43) Pub. Date: Oct. 24, 2013

(54) LASER LIGHT SOURCE MODULE

(71) Applicants: Akira Yokoyama, Chiyoda-ku (JP); Motoaki Tamaya, Chiyoda-ku (JP); Takayuki Yanagisawa, Chiyoda-ku (JP)

(72) Inventors: Akira Yokoyama, Chiyoda-ku (JP); Motoaki Tamaya, Chiyoda-ku (JP); Takayuki Yanagisawa, Chiyoda-ku (JP)

(73) Assignee: MITSUBISHI ELECTRIC CORPORATION, Chiyoda-ku (JP)

(21) Appl. No.: 13/979,026

(22) PCT Filed: Jan. 17, 2011
(86) PCT No.: PCT/JP2011/000193

§ 371 Date: Jul. 10, 2013

(51) Int. Cl. F21V 29/00

(52) U.S. Cl. CPC F21V 29/002; F21V 29/008
USPC 362/259

(57) ABSTRACT

A laser light source module includes a laser light source outputting laser light, a wavelength conversion element converting a wavelength of the laser light, a temperature sensor mounted on a first face of the wavelength conversion element, a heater substrate of a ceramic base material, on which the wavelength conversion element is mounted. A heater is provided on the heater substrate, in which a sub-mount substrate on which the laser light source is mounted and the heater substrate are fixed to a heat sink, and the heat sink includes a concavity at a position corresponding to a projection region of the wavelength conversion element opposite to the substrate, whereby the entire wavelength conversion element is kept at the most suitable operation temperature, and laser light can be wavelength-converted in higher efficiency.

### TECHNICAL FIELD

The present invention relates to a laser light source module, used for an image display device or the like, provided with a solid laser for oscillating a fundamental-wave laser light and a wavelength conversion element for converting the wavelength of the fundamental-wave laser light.

### BACKGROUND ART

As a laser light source module, a method of converting, through a wavelength conversion element using non-linear optical crystal (hereinafter, referred to as NLO crystal) having a periodical polarization inversion structure, a wavelength of laser light excited using a laser light source such as a solid laser has been practically implemented, and various kinds of laser light source modules have been proposed. However, because the wavelength conversion element using the NLO crystal has large temperature dependence of the wavelength conversion efficiency, when the wavelength conversion element is used, the entire wavelength conversion element is necessary to be kept at a constant most suitable operation temperature.

For example, in a laser light source module described in Patent Document 1, a heater and a heat diffusion plate are independently placed on a substrate fixed on a heat sink, and a wavelength conversion element is mounted on the heat diffusion plate. Temperature control of the wavelength conversion element is performed by heating the heater according to the temperature detected by a temperature sensor fixed on the substrate, to conduct the heat to the wavelength conversion element through the heat diffusion plate, so that the temperature of the wavelength conversion element is kept uniform. In the laser light source module of this type, because the heat diffusion plate, the heater, and the temperature sensor are mounted on a single substrate face, downsizing of the module is difficult to perform. Additionally, because the temperature sensor does not detect the temperature of the wavelength conversion element, the accuracy of the temperature control is low.

On the other hand, in a light source device described in Patent Document 2, a wavelength conversion element is fixed on a heat sink provided with a cavity, and a heat diffusion plate and a heater are provided on the wavelength conversion element. A temperature sensor is directly fixed to the wavelength conversion element by being inserted into the cavity of a support, and thereby detects the temperature. Because the heat sink is made to be approximately the same size as that of the wavelength conversion element, the structure around the wavelength conversion element is smaller than the example in Patent Document 1. The downsizing of the wavelength conversion element is important for downsizing or thinning a projection-type display device using a laser light source module.

### PRIOR ART DOCUMENTS

### Patent Documents

### [Patent Document 1]

International Laid-Open Patent Publication No. WO2009/116134.

### [Patent Document 2]

Japanese Laid-Open Patent Publication No. 2008-153332.

### DISCLOSURE OF THE INVENTION

### Problems to be Solved by the Invention

However, in the light source device described in Patent Document 2, because the wavelength conversion element is supported by the heat sink provided with the cavity, and thus heat radiation is performed, temperature difference is easy to occur between a portion with which the heat sink of the wavelength conversion element is in contact and other portions. Therefore, a problem has been that, because a temperature range of the entire wavelength conversion element is difficult to be controlled in a suitable range for operation, the wavelength conversion efficiency is difficult to be maximized.

An objective of the present invention, which is made in view of the above mentioned situation, is to provide a small-sized laser light source module, in which the entire wavelength conversion element is kept at the most suitable operation temperature, and by which a wavelength of laser light can be converted in high efficiency.

### Means for Solving the Problem

A laser light source module according to the present invention includes a laser light source for outputting laser light, a wavelength conversion element for converting a wavelength of the laser light, a temperature sensor mounted on a first face of the wavelength conversion element, a heater substrate formed of ceramic, on which the wavelength conversion element is mounted, having a heater for heating the wavelength conversion element from a second face of the wavelength conversion element opposite to the first face of the wavelength conversion element, and a heat sink on which the heater substrate is mounted, in which the heater is provided at a position, including a projection region of the second face of the wavelength conversion element, on a surface of the heater substrate, and the heat sink supports the heater substrate at an outer side of the projection region of the second face of the wavelength conversion element.

### Advantageous Effect of the Invention

According to the present invention, because it has been configured in such a way that the heater is provided at the position including the projection region of the wavelength conversion element, and the heat sink supports the heater substrate at the outer side of the projection region of the wavelength conversion element, the temperature of the wavelength conversion element has become possible to be kept approximately uniform in the element, and within the most suitable temperature range; therefore, the small-sized laser light source module having a higher wavelength conversion efficiency can be obtained.

### BRIEF DESCRIPTION OF DRAWINGS

FIG. 1 is a perspective view illustrating a configuration of a laser light source module according to Embodiment 1;

FIG. 2 is a side view illustrating a configuration of the laser light source module according to Embodiment 1;

FIG. 3 is a front view illustrating a configuration around a wavelength conversion element of the laser light source module according to Embodiment 1;

FIG. 4 includes plane views illustrating details of a heater substrate;

FIG. 5 is a front view illustrating a configuration around a wavelength conversion element of a laser light source module according to Embodiment 2; and

FIG. 6 is a perspective view illustrating a configuration of a laser light source module according to Embodiment 3.

### BEST MODE FOR CARRYING OUT THE INVENTION

### Embodiment 1

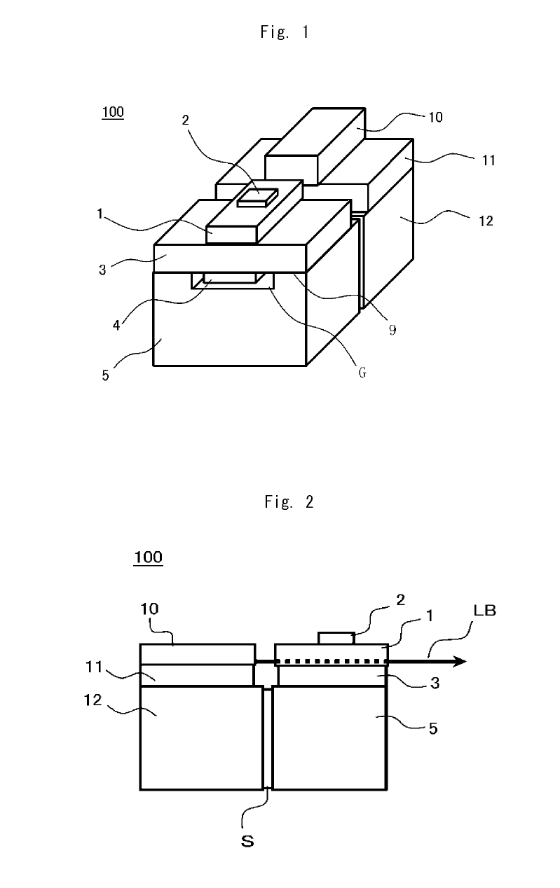

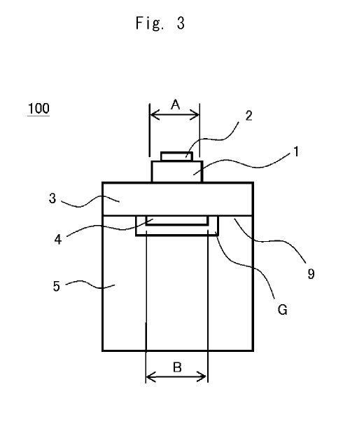

FIG. 1 is a perspective view illustrating a configuration of a laser light source module according to Embodiment 1, and FIG. 2 is a side view illustrating a configuration of the same laser light source module. FIG. 3 is a front view, viewed from an exit side of laser light, illustrating a configuration around a wavelength conversion element of the same laser light source module. In a laser light source module 100 represented in these figures, a laser light source 10 and a wavelength conversion element 1 as main components, a sub-mount substrate 11 on which the laser light source 10 is mounted, a first heat sink 12 on which the sub-mount substrate 11 is mounted, a heater substrate 3 on which the wavelength conversion element 1 is mounted, and a second heat sink 5 on which the heater substrate 3 is mounted are arranged. Here, the first heat sink 12 and the second heat sink 5 are joined to be integrated with each other, and serve as a single heat sink as a whole.

As the wavelength conversion element 1, two types, a bulk type and a waveguide type, can be used; however, an explanation will be made here on the assumption that the waveguide type is used. A waveguide for laser light LB is formed on the under face of the waveguide-type wavelength conversion element 1, where this face corresponds to a fixed face of the wavelength conversion element 1. On the other hand, on the opposing upper face of the wavelength conversion element 1, a temperature sensor 2 is mounted. The upper face and the waveguide-side under face of the wavelength conversion element 1 are in parallel to each other, and the wavelength conversion element 1 generally has a thin rectangular shape. On a side of a heater substrate 3 opposite to the face on which the wavelength conversion element 1 is mounted, a planar heater 4 having an area equal to or wider than the mounting region of the wavelength conversion element 1 is provided. The second heat sink 5 is provided with a concavity G at a position including a projection region of the wavelength conversion element 1, where the heater 4 is inserted in the concavity G provided on the under face of the heater substrate 3. That is, the heat sink 5 supports the heater substrate 3 at outer positions of the projection region.

On the other hand, the heater 4 is placed at a position including the projection region of the wavelength conversion element 1, on the under face of the heater substrate 3. The heater substrate 3 is supported by two outer edges 9 forming the concavity G, and thus, an actually heat-generating region of the heater 4 is not directly in contact with the second heat sink 5. That is, because the heater 4 is practically separated from the second heat sink 5 with a certain minute distance, the thermal coupling to the heater 4 is weakened. A space where both sides are separated to each other may be filled with air; however, thermally insulating and electrically insulating resin material or the like may also be filled therein as needed. Here, in the specification, the “mount” indicates fixation so as to be a form in which a member is placed onto another member, which includes intervention of bonding material, a later-described heat diffusion layer, or the like between both the members.

The laser light source 10 is an element for supplying laser light into the wavelength conversion element 1, which is, for example, a semiconductor laser element, or a solid laser element including laser crystal. When the laser light source 10 is a solid laser element, laser oscillation occurs by excitation using semiconductor laser or the like, which is not illustrated. The sub-mount substrate 11 is a ceramic substrate made of alumina or aluminum nitride, on which a wiring pattern is formed when a semiconductor laser diode as the laser light source 10 is mounted.

The above described laser light source 10 is fixed to be mounted on the upper face of the sub-mount substrate 11 by bonding material (not illustrated). The sub-mount substrate 11 is fixed to the upper face of the first heat sink 12 by bonding material (not illustrated). As each of the above described bonding materials, material such as various kinds of solder material, bonding material of a type of sintering metal particles, bonding material of diffusing different metals, an electrically conductive adhesive including metal particles, and an electrically non-conductive adhesive composed of resin material such as epoxy resin or silicone resin is appropriately used. Here, bonding materials in the following explanation can also be similarly used.

The sub-mount substrate 11 is a planar member produced by ceramic such as alumina, aluminum nitride, silicon nitride, boron nitride, or silicon carbide, or by material including any of them. Additionally, metal material such as tungsten or molybdenum whose thermal expansion coefficient is relatively small, alloy material including any of them, glass material, or metal-impregnated silicon-carbide material can also be used. The first heat sink 12 and the second heat sink 5 are members produced by metal material or alloy material having higher thermal-conductivity.

In the wavelength conversion element 1, for example, potassium niobate or lithium niobate is used as the NLO crystal, and the waveguide having a periodical polarization inversion structure is formed. When the wavelength conversion element 1 is used as one of light sources of a projection-type display device, the planar shape of the wavelength conversion element 1 is, for example, a rectangle having a side length of 2 mm to 5 mm. The wavelength conversion element 1 is accurately placed so that the laser light oscillated from the laser light source 10 is incident on an end face of the waveguide, which is fixed to mount on the upper face of the heater substrate 3 by bonding material (not illustrated). The wavelength conversion element 1 is joined so that the waveguide is positioned to face the heater substrate 3. The temperature sensor 2 is fixed on the upper face of the wavelength conversion element 1 by bonding material (not illustrated), while the heater 4 is formed on the under face of the heater substrate 3.

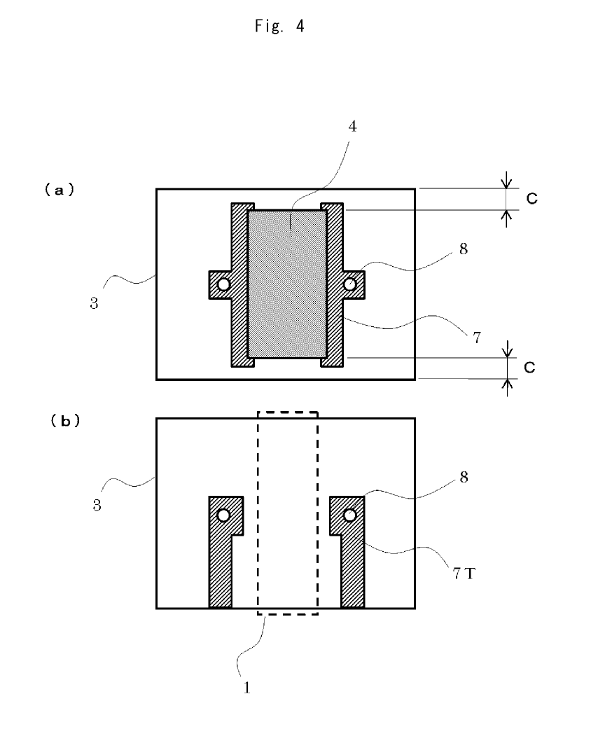

The heater substrate 3 on which the wavelength conversion element 1 is mounted is a planar insulating member produced by ceramic such as alumina, aluminum nitride, silicon nitride, boron nitride, or silicon carbide, or by material including some of them. As these ceramic material, material having a thermal expansion coefficient (a linear expansion coefficient) of 10 ppm/degree C. or less and having a thermal conductivity higher than that of the crystal material by which the wavelength conversion element 1 is configured is suitable. FIG. 4 includes plane views illustrating the substrate on which the heater is formed, where FIG. 4(a) represents a heater face, while FIG. 4(b) represents its reverse side wiring connection face. On the heater face and the wiring connection face of the heater substrate 3, circuit patterns 7 and terminal-side circuit patterns 7T for conducting electricity to the heater 4 are formed, respectively, and the conduction between the faces is performed via through-holes 8 drilled in the heater substrate 3. A practical heat-generation region of the heater 4 is a portion between the two circuit patterns 7. A region surrounded by dotted lines in the figure represents an example of a projection region where the wavelength conversion element 1 is placed.

The second heat sink 5 is fixed and mechanically joined to a side face of the first heat sink 12 using bonding material S such as epoxy resin, and the joined heat sinks can be regarded as a single heat sink as a whole. A bonding operation between both the heat sinks includes a process of position alignment between the laser light source 10 and the wavelength conversion element 1; therefore, the dimensional accuracy of the members and jigs, the temperature condition, etc., are necessary to be carefully considered. Because the heat sink is separated to the first heat sink 12 and the second heat sink 5, after assembly of both the heat sinks has been completed, positional relation between the laser light source 10 and the wavelength conversion element 1 can be adjusted. Therefore, comparing with a case of an integrated heat sink, restriction of thickness accuracy of respective bonding portions under the wavelength conversion element 1, under the heater substrate 3, under the laser light source 10, and under the sub-mount substrate 11 is relaxed, and thereby the production of the laser light source module 100 becomes easier.

On the other hand, an integrated heat sink has an advantage that, in addition to only one heat sink being required, a bonding process between the heat sinks is saved. However, because the thicknesses of two bonding portions between the heat sink and the wavelength conversion element 1, and between the heat sink and the sub-mount substrate 11 are necessary to be accurately controlled, consideration is necessary for controlling each thickness during the production.

Because the wavelength conversion efficiency of the wavelength conversion element 1 has temperature dependence as described later, it is necessary to keep the wavelength conversion element 1 at a specified temperature during operation of the laser light source module 100. The temperature sensor 2 is a device for detecting the temperature of the wavelength conversion element 1, for example, a thermistor is used therefor.

As illustrated in FIG. 3, the width B of the heater 4 is approximately the same as or wider than the width A of the wavelength conversion element 1, and regarding a depth direction in FIG. 3, that is, a direction along the wave guide, although the length of the heater 4 is a little shorter than that of the wavelength conversion element 1, the heater 4 has a length approximately the same as that of the wavelength conversion element 1.

Actually, in order to prevent the heater substrate 3 from interfering with the laser light LB, the inlet end and outlet end through which the laser light LB is inputted to and outputted from the waveguide of the wavelength conversion element 1 are often placed so as to protrude a little from both ends of the heater substrate 3. In other words, in the laser light LB direction, the wavelength conversion element 1 is a little longer than the heater substrate 3. In order to uniform the temperature of the wavelength conversion element 1, the protrusion length is desired to be as small as possible. However, from restriction on the manufacturing process, the wavelength conversion element 1 having the protrusion length of, for example, approximately 0.05 mm to 0.3 mm is used. By protruding the ends of the wavelength conversion element 1, the bonding material provided between the heater substrate 3 can also be prevented from spreading to the ends of the wavelength conversion element 1.

In addition, according to a problem in the process, the heater 4 is not easy to form up to the ends of the heater substrate 3. Therefore, as represented in FIG. 4(a), clearances C are provided from edges of the heater 4 to those of the heater substrate 3, where the widths of the clearances C are, for example, 0.1 mm to 0.5 mm. The wavelength conversion element 1 is also extended over the clearances C, and protrudes over the heater substrate 3; therefore, regarding the laser light LB direction, the heater 4 is structured to be a little shorter than the wavelength conversion element 1.

In Embodiment 1, the heater 4 heats the wavelength conversion element 1 through the heater substrate 3. As described above, because the heater 4 is arranged on the waveguide side of the wavelength conversion element 1 corresponding to almost the entire area of the wavelength conversion element 1, the whole crystal of the wavelength conversion element 1 can be almost uniformly heated. For example, when the thickness of the heater substrate 3 is 0.3 mm to 1.0 mm, if the length of the heater 4 is longer than 70% of the wavelength conversion element 1 in the laser light LB direction, the conversion efficiency of the wavelength conversion element 1 does not seriously deteriorate, so that the system can be of practical use.

The heater 4 is formed by coating electrically resistant paste including ruthenium oxide or the like on the heater substrate 3, then drying and baking it. The temperature sensor 2 and the heater 4 are electrically connected to an external circuit (not illustrated) through the terminal-side circuit patterns 7T, and the output power of the heater 4 is controlled by the external circuit so that the wavelength conversion element 1 becomes the most suitable operation temperature.

Next, each component is explained in detail based on the operation of the laser light source module. In the laser light source module 100 having a structure as described above, the laser light oscillated from the laser light source 10 is incident on the wavelength conversion element 1 and converted in wavelength, and then outputted from the wavelength conversion element 1, for example, as a second harmonic wave. In FIG. 2, the laser light LB oscillated from the laser light source module 100 is represented.

The wavelength conversion element using the NLO crystal performs high-efficient wavelength conversion, when a phase matching condition is satisfied. That is, when a phase velocity of a non-linear polarization wave compulsively excited by incident fundamental wave laser light and a phase velocity of the second harmonic wave oscillated by the non-linear polarization are matched with each other, light waves oscillated at each position in the element are coherently added, so that a higher conversion efficiency can be obtained. However, the wavelength conversion element has characteristics that the conversion efficiency has a peak value at a specified temperature, and the width of, for example, approximately 10 to 20 degrees C. exists from a temperature where the conversion efficiency increases to a temperature where the conversion efficiency decreases through the peak thereof. Therefore, when the system is actually used, preferably the system is necessary to be maintained within the temperature range of approximately ±2 degrees C. around the peak temperature. The most suitable operation temperature and a permissible temperature range during the operation of the wavelength conversion element 1 can be appropriately adjusted by setting a polarization inversion period. For example, the wavelength conversion element 1 having the most suitable operation temperature of 90 to 130 degrees C. is often used.

Accompanying the operation of the laser light source module 100, caused by part of energy of the laser light LB transforming inside the wavelength conversion element 1 into heat, the wavelength conversion element 1 itself generates heat. Therefore, in order to prevent decrease of wavelength conversion efficiency due to temperature change of the wavelength conversion element 1 in response to the laser output change, the output power of the heater 4 is necessary to be dynamically controlled.

The entire under face of the wavelength conversion element 1 is adhered to the substrate, and the heater 4 having the width size approximately the same as or larger than the wavelength conversion element 1 is arranged under the wavelength conversion element, whereby the lower face of the wavelength conversion element 1 can be uniformly heated. Regarding a ceramic plate used as the heater substrate 3, the thickness of 0.3 to 1.0 mm is preferable. The thermal conductivity of 6 W/(m·K) of lithium niobate is relatively small, and the thermal conductivity of alumina, for example, is more than five times that value; therefore, the heater substrate 3 also functions as a heat diffusion plate.

The heater 4 is fixed to a face of the heater substrate 3 opposite to that on which the wavelength conversion element 1 is mounted. The heater 4 is placed while being inserted into the concavity G of the second heat sink 5 and separated from the second heat sink 5. Accordingly, dissipation heat from the wavelength conversion element 1 is transmitted along a path to the second heat sink 5 through a cross section of the heater substrate 3. That is, the thermal conduction from the wavelength conversion element 1 to the second heat sink 5 is structurally controlled, and thus considered so that the temperature variation rate is not too high in response to rapid variation of a load. A mounting area of the heater substrate 3 on the second heat sink 5 is designed so that, when the laser light source module 100 is driven without using the heater 4, the temperature of the wavelength conversion element 1 is lower than a specified temperature and is close to the specified temperature. By maintaining the specified temperature close to that at which the conversion efficiency reaches the peak, the output power from the heater 4 can be decreased when laser light source module 100 is driven, and thus by using a relatively low power heater 4 in a configuration as represented in FIG. 4, the temperature of the wavelength conversion element can be uniformly maintained within a range of ±2 degrees C. Here, considering the temperature difference from the room temperature and the bonding material between both the heat sinks, the present invention is effective in controlling the temperature especially in a range of 80 to 150 degrees C.

Especially, in the waveguide-type wavelength conversion element by which the high-efficiency wavelength conversion can be performed, because the waveguide is formed on a plane of the crystal, waveguide-side temperature distribution is important. Because the thickness of the waveguide is extremely thin, for example, approximately several μm to 50 μm, considering not only the temperature distribution but also positional variation in the thickness direction due to the temperature variation of the NLO crystal, the waveguide side thereof is generally arranged on the supporting side such as the heat sink.

As an example, assuming a case of the waveguide thickness of 10 μm or thinner, structural effect of the operation temperature is examined. For example, when the alumina substrate (thermal expansion coefficient: 7 ppm/degree C.) having the thickness of 0.6 mm is used as the heater substrate 3, as the temperature increases from 20 degrees to 120 degrees, expansion of approximately 0.4 μm of the heater substrate 3 occurs in the thickness direction. Even if alignment accuracy of ±0.5 μm between the laser light source 10 and the wavelength conversion element 1 in the vertical direction is considered, because this expansion is settled within a range of 2 μm as a total error margin, a problem does not occur. Additionally, because the waveguide is provided on the side of the heater substrate 3, deformation of the wavelength conversion element 1 in the thickness direction is not necessary to be considered.

That is, by using a thin-plate-type ceramic substrate having a low thermal expansion coefficient as the heater substrate 3, the positional accuracy in the vertical direction can be satisfied. It is needless to say that, even if a size value or a thermal expansion coefficient different from the above setting values are used, appropriate design can be performed so as to be settled within the above range.

Due to the temperature sensor 2 and the wavelength conversion element 1 being in contact with each other, temperature detection accuracy of the temperature sensor 2 is relatively high, and responsiveness thereof is excellent. Accordingly, also in a case of rapid output variation of the laser light for converting the wavelength, the heater 4 is easy to be controlled so that the temperature of the wavelength conversion element 1 is kept constant at the most suitable operation temperature. Therefore, not only when the system is operated, but also when the laser light source module 100 is switched from an off-state to an on-state, it is possible to increase the temperature up to the operation temperature at high speed while preventing an excess of the temperature. Accordingly, a rise time of an imaging device on which the laser light source module 100 of Embodiment 1 is mounted from the power-on to the operation state can be shortened.

According to Embodiment 1, while the relatively small-sized laser light source module 100 is realized using the heater substrate 3 and the second heat sink 5 for the wavelength conversion element 1, the temperature of the waveguide provided on the wavelength conversion element 1 is controlled to be uniform and constant at the most suitable operation temperature, so that a higher wavelength conversion efficiency can be obtained.

### Embodiment 2

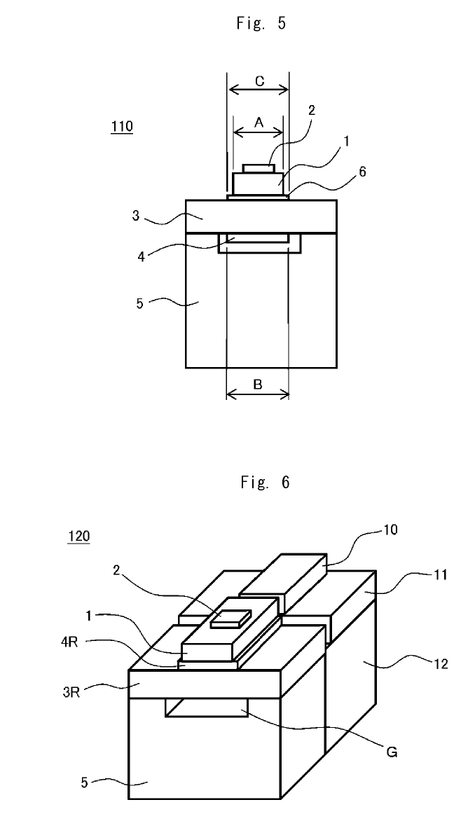

FIG. 5 illustrates a structure around the wavelength conversion element 1 of a laser light source module 110 according to Embodiment 2. Among the components represented in FIG. 5, regarding the components common to those represented in FIG. 1 to FIG. 3, the same reference numerals as those used in FIG. 1 to FIG. 3 are given, and their explanation is omitted. The laser light source module 110 has a feature that a heat diffusion layer 6 is used between the wavelength conversion element 1 and the heater substrate 3, in which the wavelength conversion element 1 is mounted on a surface of the heat diffusion layer 6 while facing the waveguide side thereof to a side of the heat diffusion layer 6. The heat diffusion layer 6 is configured with a thick film layer including highly thermal-conductive micro-particles such as silver, or a metal thin plate or metal foil including copper as a main component.

By forming the heat diffusion layer 6 having a width C approximately the same as or wider than the width A of the wavelength conversion element 1 on the upper face of the heater substrate 3, the heat generated from the heater can be diffused, and the waveguide temperature on the under face of the wavelength conversion element 1 can accurately be kept uniform. An improvement of the waveguide-temperature uniformity makes it easy to maximize the wavelength conversion efficiency of the laser light LB by the wavelength conversion element 1.

When the heat diffusion layer 6 is a thick film layer, screen printing is previously performed on the heater substrate 3 using thick film paste, and, after drying, the wavelength conversion element 1 is mounted thereon, and then they are put into a heat treatment process such as a curing process or a baking process, whereby the bonding operation of the wavelength conversion element 1 with the heater substrate 3 can be included therein. Preferably the thickness of the thick film layer after the heat treatment is approximately 10 to 50 μm for ensuring thickness uniformity. The thick film paste to be used preferably includes a lot of silver particles whose thermal conductivity is high, and further includes resin and/or low-melting-point glass. Alternatively, if the material not including the resin and the low-melting-point glass remaining after the baking process but including the sintering material leaving almost only silver after the baking process is used, the heat diffusion layer 6 having an excellent heat diffusion effect can be obtained. Because the thick film layer is extremely thinner comparing with the heater substrate 3, an effect on aligning accuracy between the laser light source 10 and the wavelength conversion element 1 can be neglected.

When the heat diffusion layer 6 is a metal thin plate, the metal thin plate and the heater substrate 3, and the metal thin plate and the wavelength conversion element 1 are necessary to be bonded by bonding material. When a copper plate (thermal expansion coefficient: 17 ppm/degree C.) having the thickness of 0.2 mm is used as the metal thin plate, with the temperature variation of 100 degrees C., expansion of 0.34 μm in the thickness direction occurs. This value is an error component added to the expansion of the heater substrate 3; however, even if addition to the expansion component of the heater substrate 3 is performed, designing is possible so as to be within a total error margin. Here, because the thickness of each bonding material is approximately 10 μm or thinner, it can be neglected.

When the heat diffusion layer 6 is metal foil, a method can be used in which the metal foil is bonded to the heater substrate 3 through brazing material to which active metal is added, or the metal foil is directly joined to the heater substrate 3 by heating the metal foil at the temperature exceeding the melting point of the metal foil while the metal foil is placed on the heater substrate 3.

In each method with respect to the above heat diffusion layer 6, when the waveguide is thicker than the previously described size, the error margin is also increased accordingly; therefore it is needless to say that the thickness of the heat diffusion layer 6 can also be appropriately adjusted.

Because the heat diffusion layer 6 has conductivity, the terminal-side circuit patterns 7T formed on the upper face of the heater substrate 3 are necessary to be considered so as not to make contact therewith. For this problem, it is only necessary to ensure a gap enough to ensure insulation between the terminal-side circuit patterns 7T and the heat diffusion layer 6. On the other hand, when a sufficient gap cannot be ensured, the insulation can be ensured by forming an insulation coating film such as a glass film at a region where the heat diffusion layer 6 is overlapped on the terminal-side circuit patterns 7T.

Additionally, because the point that the heater 4 is inserted inside the concavity G of the second heat sink 5, and arranged to separate from the second heat sink 5 is the same as that in Embodiment 1, the thermal conductivity from the wavelength conversion element 1 to the second heat sink 5 is structurally suppressed. Accordingly, using the low power heater 4, the temperature of the wavelength conversion element can be uniformly maintained in a permissible temperature range.

According to Embodiment 2, while a relatively small-sized laser light source module 110 is realized using the heater substrate 3 and the second heat sink 5 for the wavelength conversion element 1, the temperature of the waveguide of the wavelength conversion element 1 is controlled to be kept uniform and constant at the most suitable operation temperature, so that the higher wavelength conversion efficiency can be obtained.

### Embodiment 3

FIG. 6 is a perspective view illustrating a configuration of a laser light source module 120 according to Embodiment 3. Regarding components represented in FIG. 6, when the components are common to those represented in FIG. 1 to FIG. 3, the same reference numerals are used.

The laser light source module 120 has a feature that a heater 4R is arranged between the wavelength conversion element 1 and a heater substrate 3R, in which the wavelength conversion element 1 is mounted on a surface of the heat 4R while facing the waveguide side to a side of the heat 4R. Comparing with the laser light source module 100 in FIG. 1, in the laser light source module 120, positional relationships of the heater substrate 3 and the heater substrate 3R to the heater are opposite. The heater substrate 3R is a member similar to that of the heater substrate 3, while the heater 4R is to the heater 4. Because a resistance value of the heater 4R is necessary to be adjusted to the design value, the wavelength conversion element 1 is fixed on the heater 4R, which is previously formed, by using bonding material. Because the heater 4R is positioned on an upper side in FIG. 6, the terminal-side circuit patterns 7T are formed so as to position inside the concavity G, or an insulation film such as a glass film is formed, whereby insulation with the second heat sink 5 may be ensured.

The concavity G of the second heat sink 5 positions at a region including a projection region, of the wavelength conversion element 1, facing the heater substrate 3R, whereby the thermal conduction from the wavelength conversion element 1 to the second heat sink 5 is structurally suppressed. Accordingly, the temperature of the wavelength conversion element can be uniformly maintained within the permissible temperature range using the low power heater 4R.

Because the wavelength conversion element 1 is directly fixed on the heater 4R, when heat-generation uniformity of the heater 4R is higher, the temperature uniformity of the wavelength conversion element 1 is ensured. Because a relatively low power heater is enough for the heater 4R, a low resistance film by which the heat-generation uniformity is easy to obtain can be used. In a manufacturing process of the heater 4R, in order to increase surface smoothness of the heater 4R, a method is known in which a leveling operation is performed by giving ultrasonic vibration to the heater substrate 3R after the screen printing. Due to the excellent smoothness, the joining with the wavelength conversion element 1 is uniformed, and the temperature uniformity of the wavelength conversion element 1 is improved.

In order to increase the heat-generation uniformity of the heater 4R, instead of the thick film resistor by the screen printing, a resistor green sheet previously cut into a specified size may be pasted and baked to use. By using the resistor green sheet, the heater 4R having excellent thickness uniformity and surface smoothness can be obtained.

When the heater 4R is a thick film heater, because the thickness of the thick film layer is 50 μm or thinner after the baking, an effect on aligning accuracy between the laser light source 10 and the wavelength conversion element 1 can be neglected. When the heater 4R is a thin film heater, because the effect is further decreased, it can be similarly neglected.

According to Embodiment 3, while a relatively small-sized laser light source module 120 is realized using the heater substrate 3R and the second heat sink 5 for the wavelength conversion element 1, the temperature of the waveguide of the wavelength conversion element 1 is controlled to be kept uniform and constant at the most suitable operation temperature, so that the higher wavelength conversion efficiency can be obtained.

Here, it is needless to say that the above described resistor green sheet can be used as the heater in Embodiment 1 and in Embodiment 2.

### EXPLANATION OF REFERENCES

1: Wavelength conversion element
2: Temperature sensor
3, 3R: Heater substrate
4, 4R: Heater
5: Second heat sink
6: Heat diffusion layer
7: Circuit pattern
7T Terminal-side circuit pattern
8: Through-hole
9: Outer edge
10: Laser light source
11: Sub-mount substrate
12: First heat sink
G: Concavity
LB: Laser light

1. A laser light source module comprising:
a laser light source for outputting laser light;
a wavelength conversion element for converting a wavelength of the laser light;
a temperature sensor mounted on a first face of the wavelength conversion element;
a first substrate formed of ceramic, on which the wavelength conversion element is mounted, having a heater for heating the wavelength conversion element from a second face, opposite to the first face, of the wavelength conversion element; and
a heat sink on which the first substrate is mounted;
the heater being provided at a position, including a projection region of the second face, on a surface of the first substrate, and
the heat sink supporting the first substrate at an outer side of the projection region of the second face.

2. A laser light source module as recited in claim 1, wherein the heater is provided on a face of the first substrate opposite to a face thereof on which the wavelength conversion element is mounted,
the heat sink has a concavity at a position including the projection region of the second face,
an outer edge of the concavity supports the first substrate, and
a heat generation portion of the heater is arranged to be inserted into the concavity and separated from the heat sink.

3. A laser light source module as recited in claim 1, wherein the laser light source is mounted on a second substrate, and
the second substrate is mounted on the heat sink.

4. A laser light source module as recited in claim 3, wherein the heat sink includes a first heat sink on which the first substrate is mounted, and a second heat sink on which the second substrate is mounted, and
the first heat sink and the second heat sink are bonded to each other.

5. A laser light source module as recited in claim 1 further comprising:
a heat diffusion layer on a surface of the first substrate, wherein the wavelength conversion element is mounted on a surface of the heat diffusion layer in such a way that the second face of the wavelength conversion element faces the heat diffusion layer.

6. A laser light source module as recited in claim 5, wherein the heat diffusion layer is configured with a thick film layer including silver particles.

7. A laser light source module as recited in claim 5, wherein the heat diffusion layer is configured with a metal thin plate or metal foil bonded to the first substrate.

8. A laser light source module as recited in claim 1, wherein the wavelength conversion element is mounted on a surface of the heater with the second face thereof facing the heater.

9. A laser light source module as recited in claim 1, wherein the wavelength conversion element includes a waveguide through which the wavelength of the laser light is converted, and the waveguide is formed to face the second face of the wavelength conversion element.

10. A laser light source module as recited in claim 2, wherein the wavelength conversion element includes a waveguide through which the wavelength of the laser light is converted, and the waveguide is formed to face the second face of the wavelength conversion element.

11. A laser light source module as recited in claim 3, wherein the wavelength conversion element includes a waveguide through which the wavelength of the laser light is converted, and the waveguide is formed to face the second face of the wavelength conversion element.

12. A laser light source module as recited in claim 4, wherein the wavelength conversion element includes a waveguide through which the wavelength of the laser light is converted, and the waveguide is formed to face the second face of the wavelength conversion element.

13. A laser light source module as recited in claim 5, wherein the wavelength conversion element includes a waveguide through which the wavelength of the laser light is converted, and the waveguide is formed to face the second face of the wavelength conversion element.

14. A laser light source module as recited in claim 6, wherein the wavelength conversion element includes a waveguide through which the wavelength of the laser light is converted, and the waveguide is formed to face the second face of the wavelength conversion element.

15. A laser light source module as recited in claim 7, wherein the wavelength conversion element includes a waveguide through which the wavelength of the laser light is converted, and the waveguide is formed to face the second face of the wavelength conversion element.

16. A laser light source module as recited in claim 8, wherein the wavelength conversion element includes a waveguide through which the wavelength of the laser light is converted, and the waveguide is formed to face the second face of the wavelength conversion element.
